(19) United States
(12) Patent Application Publication
(10) Pub. No.: US 2002/0059691 A1
(43) Pub. Date: May 23, 2002

(54) Disengageable doorstop for vehicles

(75) Inventor: Vittorio Audisio, Milano (IT)

Correspondence Address: SUGHRUE, MION, PLLC, 2100 Pennsylvania Avenue, NW, Washington, DC, 20037-3213, US

(73) Assignee: GAMMASTAMP SPA

(21) Appl. No.: 10/046,270

(22) Filed: Jan. 16, 2002

(30) Foreign Application Priority Data
Jan. 17, 2001 (EP) 01830022.8
Oct. 22, 1999 (EP) 99830665.8

(51) Int. Cl. E05D 11/06

(52) U.S. Cl. 16/374

(57) ABSTRACT

A disengageable doorstop for vehicles, including:

a first support (16) destined to be fixed to the chassis (18) of a vehicle (10),

a tie rod (22) with one end (24) fixed to the first support (16) and free to rotate, and

a second support (36) destined to be fixed to a vehicle door (12) that is hinged to the chassis (18), the second support (36) carrying a pair of rollers (38 and 40) free to rotate around their respective axes, which are parallel to each other, and an elastic means (42) that tends to push the said rollers (38 and 40) together.

The tie rod (22) is predisposed to move between the said rollers (38 and 40) due to rotation of the door (12) between the closed position and the normal open position, and vice versa, and is predisposed for disengagement from the rollers (38 and 40) to allow the door (12) to be opened beyond the normal open position to an extra-wide open position. The other end (34) of the tie rod (22) has a rounded shape that allows the tie rod (22) to disengage itself from the rollers (38 and 40) under the effect of simply rotating the door (12) towards the said extra-wide open position from the normal open position.

The present invention relates to disengageable doorstop for vehicles.

More precisely, the invention relates to device as described in the preamble of claim 1, which is known from FR-A- 2721649. This document describes a doorstop that allows a normal door-open position with an opening angle of approximately 90° and an extra-wide position. The known device consists of a first and a second support connected together via a tie rod that is hinged to the first support and can slide between a pair of rollers carried by the second support. One end of the tie rod is shaped like a hook with a V-shaped profile that engages with one of the rollers when the door is in the normal open position. The known device is equipped with a disengagement mechanism including a handle that must be manually operated to disengage the tie rod from the rollers to open the door beyond the normal open position. In this known type of device, to open the door beyond the normal open position, the user must use the handle with one hand whilst simultaneously pushing the door towards the extra-wide opening position with the other hand. This operation can be particularly awkward when the user has his hands occupied, such as when loading or unloading the vehicle for example.

The object of the present invention is to provide a doorstop of the above-specified type that is simpler and more economical than the previously cited known device and which also allows a simplified door-opening manoeuvre to the extra-wide open position.

According to the present invention, this objective is achieved by a doorstop with the characteristics specified in Claim 1.

The present invention will now be described in detail with reference to the attached drawings, given purely as a non limitative example, where:

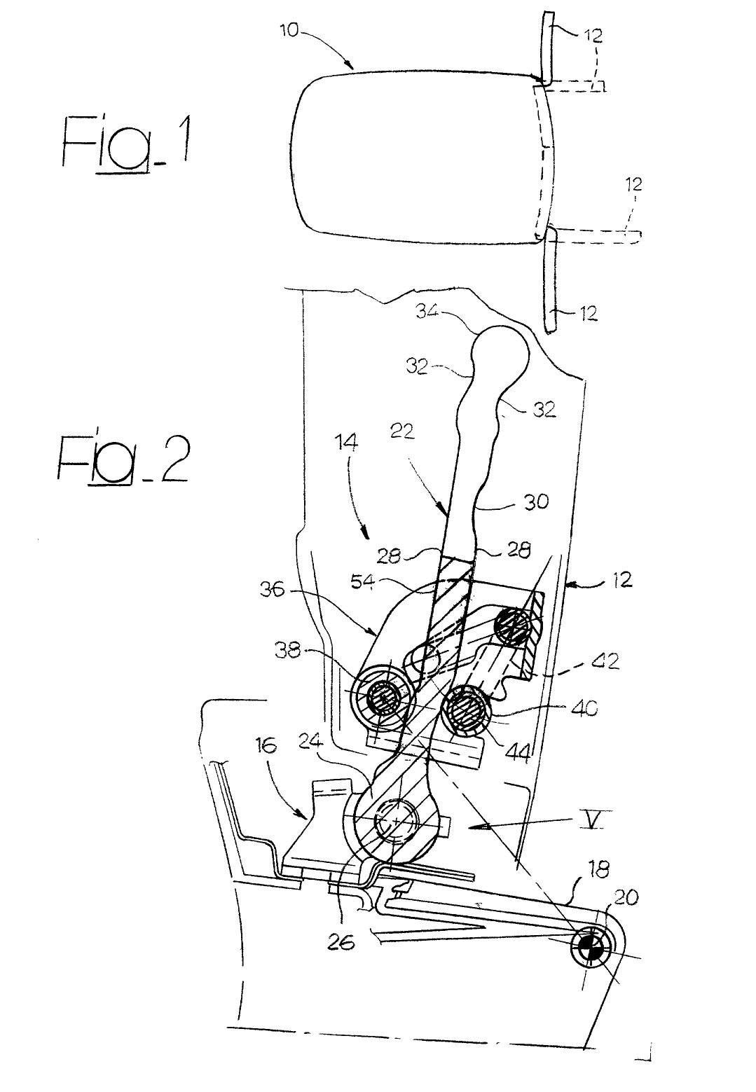

FIG. 1 is a schematic plan view of a vehicle with the rear doors equipped with the disengageable doorstops.

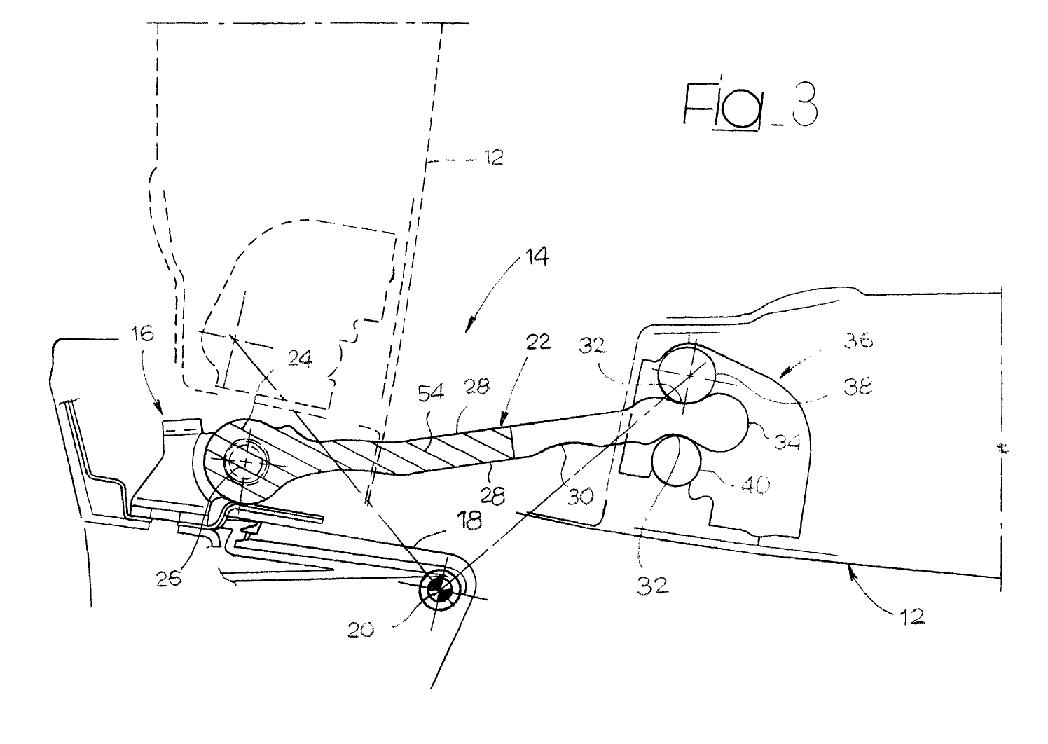

FIG. 2 is a plan view of a doorstop according to the invention in the door-closed position.

FIG. 3 is a plan view of the doorstop of FIG. 1 in the normal door-open position.

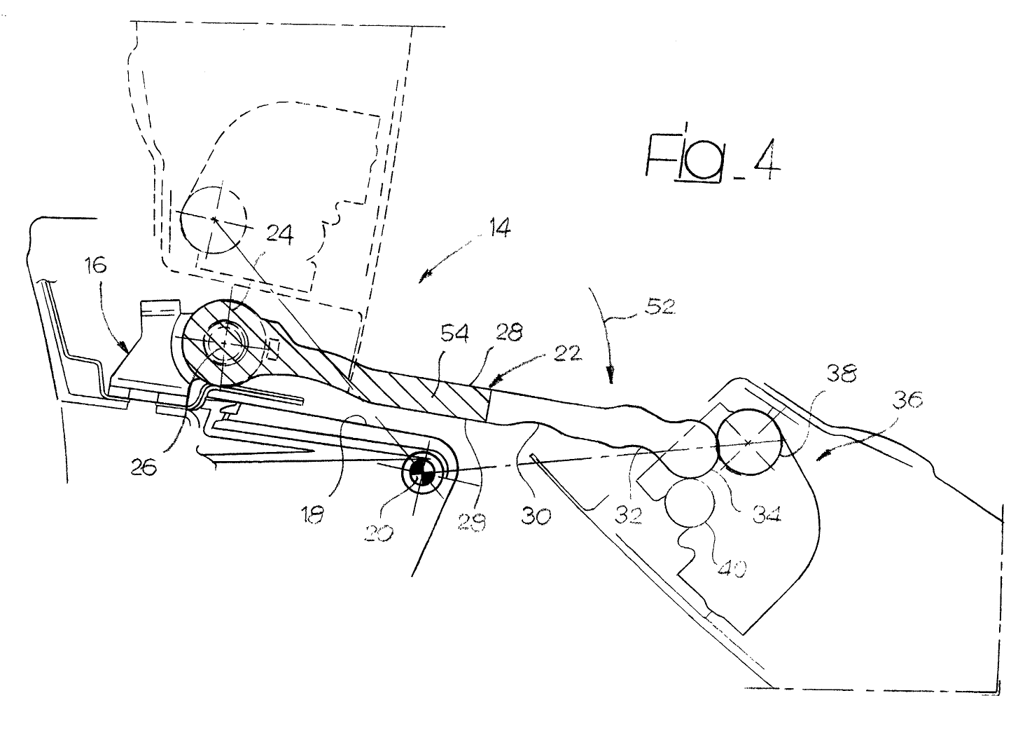

FIG. 4 is a plan view illustrating the device of FIGS. 1 and 2 in the disengaged position.

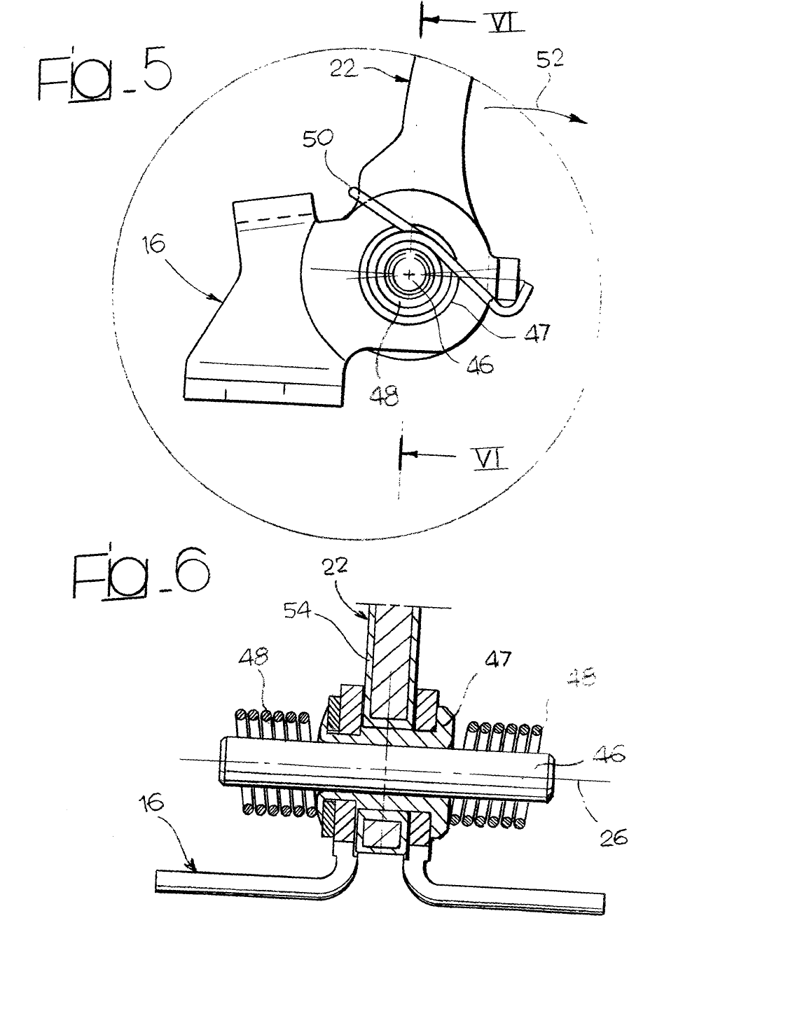

FIG. 5 is an enlargement of a detail of the part indicated by arrow V in FIG. 2, and

FIG. 6 is a cross-section along the line VI-VI of FIG. 5.

With reference to FIG. 1, 10 schematically indicates a vehicle with a pair of rear doors 12 hinged to the vehicle's chassis along their respective vertical axes. The doors are predisposed for stopping in a closed position, a normal open position of approximately 90° and an extra-wide open position, indicated in FIG. 1 with a continuous line.

With reference to FIG. 2, 3 and 4, a doorstop according to the invention is indicated as 14. The device 14 includes a first support 16, destined to be fixed to a pillar 18 forming part of the vehicle chassis 10. The pillar carries, in a known manner, the hinges for each door 12, the hinge axes of which are schematically indicated as 20.

The doorstop 14 includes a tie rod 22 with one end 24 attached to the first support and turning around an axis parallel to the hinge axis 20 of the door 12. The tie rod 22 is composed of a metal rod with two opposed rolling surfaces 28 on which the engagement seats 30 and 32 are formed. The other end 34 of the tie rod 22 has a rounded form in the plane at right angles to the rotational axis 26 of the tie rod 22. In particular, the rounded profile of the other end 34 smoothly merges with the lateral rolling surfaces 28 and, in particular, with the engagement seats 32 formed on the rolling surfaces 28 close to the rounded end 34. For reasons that will be explained in the following, the rounded profile of the end 34 does not have undercut portions or a form that could cause engagement of the end part 34.

The doorstop 14 also includes a second support 36, destined to be fixed to the door 12. The second support 36 carries a first roller 38 and a second roller 40 that cooperate with the lateral rolling surfaces 28 of the tie rod 22. The first roller 38 is mounted on support 36 and free to rotate around a fixed axis. The second roller 40 is mounted to freely rotate around a mobile axis, which is elastically pushed against the first roller 38. In the embodiment illustrated in the figure by way of an example, the mobile roller 40 is mounted, free to rotate, on the end of an elastic element 42, composed of a shaped metal rod, one end 44 of which constitutes the mobile axis of rotation for the second roller 40. The elastic element 42 imparts a predetermined elastic force on the second roller 40 that tends to push it against the first roller 38. The two rollers 38 and 40 are only subjected to the action of the elastic element 42 and can thus be separated from each other by overcoming the elastic force that tends to keep them together.

With reference to FIGS. 5 and 6, the tie rod 22 is articulated on the first support 16, turning around the said axis 26 via a pivot pin 46 and a bush 48. The pivot pin 46 has two projecting parts on which two parts of a return spring 50 are inserted. The return spring 50 applies an elastic force to the tie rod that tends to make it turn in the direction indicated by arrow 52 in FIG. 5. In FIG. 6, it may be noted that the tie rod 22 has a plastic covering 54, preferably applied via co-moulding. The covering 54 extends onto the part of the tie rod shown with hatched lines in FIGS. 2, 3 and 4.

The operation of the doorstop conforming to the invention will now be described with reference to FIGS. 2, 3 and 4.

FIG. 2 illustrates the configuration of the doorstop corresponding to the door-closed position. The force exerted by the elastic element 42 pushes the rollers 38 and 40 against the lateral rolling surfaces 28 of the tie rod 22. Starting from the configuration in FIG. 2, the motion of the door opening causes a rotation of the door 12 and the second support 36 that is fixed to it around the hinge axis 20. Due to this rotation, the rollers 38 and 40 roll along the lateral sides 28 of the tie rod 22. When the rollers 38 and 40 reach the engagement seats 30, the device 14 holds the door in a partially open position and when the rollers 38 reach the other engagement seats 32, the door 12 will be in the normal open position, corresponding to an opening angle of approximately 90° (FIG. 3). The position shown in FIG. 3 is a stable stop position because a predetermined torque must be applied to the door to move it from this position.

To open the door beyond an opening angle of 90° it is sufficient, starting from the normal open position configuration illustrated in FIG. 3, to apply a torque greater than the predetermined value in the direction of opening. The rounded end 34 of the tie rod 22 allows the tie rod to spontaneously disengage itself from the rollers when the opening torque applied to the door exceeds a predetermined level, which depends on the load of the elastic element 42, the shape and the size of the tie rod end 34. After the tie rod 22 disengages itself from the rollers 38 and 40, as illustrated in FIG. 4, the door 12 is free to turn around the hinge axis 20 without impediment from the doorstop 14. The door 12 can thus be opened to the extra-wide position, corresponding to an opening angle, for example, of 180°. With reference to FIG. 4, when the tie rod 22 disengages from the rollers 38 and 40, the return spring that acts on the tie rod 22 tends to push it in the direction indicated by arrow 52 until the tie rod makes contact with the end stop. This end stop could, for example, consist of a vehicle surface, such as a surface of the rear lights unit mounted on the pillar 18. The plastic covering 54 on the surface of the tie rod 22 serves to avoid damaging vehicle surfaces when the tie rod rests against them.

The return spring 50 (FIGS. 5 and 6) keeps the tie rod 22 in a predetermined reference position when the latter is disengaged from the second support 36. When the door 12 is closed, starting from the extra-wide open position, the rollers 38 and 40 come into contact with the rounded end of the tie rod 22 when the door has an opening angle slightly greater than the normal open position. At this point, the user perceives an increase in resistance and, to engage the tie rod 22 with the rollers 38 and 40, it is sufficient to continue pushing the door 12 in the direction of closure. The rounded end 34 separates the rollers 38, 40 and the tie rod 22 spontaneously slides between the rollers.

It is clear from the above description that the manoeuvre of opening the door to the extra-wide open position does not require the operation of any disengagement mechanism by the user. A doorstop according to the invention is also particularly simple and economic due to the fact that no disengagement mechanism is required.

1. A disengageable doorstop for vehicles, including.
a first support destined to be fixed to the chassis of a vehicle,
a tie rod with a first end mounted free to rotate on the first support, and
a second support destined to be fixed to a vehicle door that is hinged to the chassis, the second support carrying a pair of rollers, free to rotate around their respective axes, which are parallel to each other, and an elastic means that tends to push the said rollers together,
wherein the tie rod is predisposed to move between the said rollers due to the rotation of the door between the closed position and the normal open position, and vice versa, and wherein the tie rod is predisposed for disengagement from the rollers to allow the door to be opened beyond the normal open position to an extra-wide open position,
wherein a second end of the said tie rod has a rounded shape that allows the tie rod to disengage itself from the rollers under the effect of simply rotating the door towards the said extra-wide open position from the normal open position.

2. A device according to claim 1, wherein said tie rod has at least one engagement seat that is engaged by at least one of the said rollers in the normal open position.

3. A device according to claim 2, wherein said engagement seat is situated in the immediate vicinity of the rounded tie rod end.

4. A device according to claim 3, wherein said rounded tie rod end smoothly merges with at least one of the said engagement seats.

5. A device according to claim 1, wherein said second support carries an elastic element composed of a shaped metal rod, on the end of which one of the said rollers is mounted and free to rotate.

6. A device according to claim 1, wherein first support includes an elastic element that tends to keep the tie rod in a reference position in which the said tie rod is disengaged from the rollers.

7. A device according to claim 6, wherein said elastic element tends to push the tie rod towards an end stop defined by a surface of the vehicle.

8. A device according to claim 7, wherein said tie rod has a covering over at least the part the tie rod that will come into contact with the said surface of the vehicle.
